(19) United States
(12) Patent Application Publication
(10) Pub. No.: US 2009/0210256 A1
(43) Pub. Date: Aug. 20, 2009

(54) System For Real-Time Online Health Care Insurance Underwriting

(75) Inventors: Prakash Upadhyayula, Plainfield, IL (US); Navaneeth Nair, Hamden, CT (US); Pramod Waingankar, Orange, CT (US); Paul Kniskern, Springfield, MA (US); Bob Lezon, Andover, CT (US); Soham Chakravarti, Middletown, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna Inc., Hartford, CT (US)

(21) Appl. No.: 12/032,497

(22) Filed: Feb. 15, 2008

(51) Int. Cl. G06Q 40/00

(52) U.S. Cl. 705/4

(57) ABSTRACT

A system for real-time health care insurance underwriting is described comprising a quotation module, a verification module, and an underwriting module. The quotation module receives user input relating to a user's health status via an online user interface. The verification module verifies the user input against information stored in a database to form a list of inconsistencies and present the user via the online user interface with a request to validate at least some information within the user input. The underwriting module automatically creates a debit score based on one or more of at least a portion of the user input and the validated information and generates an underwriting decision based at least in part on the debit score. The quotation module presents one or more offers to sell insurance to the user via the online user interface, the one or more offers based on the underwriting decision.

### FIELD OF THE INVENTION

This invention relates generally to the field of health care insurance and more specifically to the area of computerized health care insurance underwriting.

### BACKGROUND OF THE INVENTION

Insurance underwriting is the process by which a health care organization, such as an insurance company, evaluates information about an individual or group of individuals and makes a decision on whether to sell insurance to the individual or group of individuals. If an affirmative decision to insure the individual or group of individuals is made, insurance underwriting includes calculating a price at which to sell the insurance which generally involves determining a price allowing for a profit while taking into account various risks.

Underwriting insurance for an applicant, especially for medical insurance, is a complicated process involving many factors such as the applicant's demographic information, health history, personal habits, current health, history of making claims, and many other factors. Moreover, a typical health care organization may offer numerous insurance plans having various eligibility criteria. As a result, the health insurance underwriting typically involves filling out a health insurance application for review by an insurance underwriter, which is one or more persons who review the application and make a decision whether to insure the applicant and, if so, what price to charge for insurance.

Because so much information affects a decision whether to underwrite health insurance, the application process can be long and tedious. In order to provide the underwriter with a complete set of information from which to base an underwriting decision, applications typically include many questions to be answered by the applicant, a number of which may not be applicable to the applicant. A large volume of questions may cause an applicant to answer questions without much thought and reflection in order to reduce the time required to complete the application, thereby increasing the chance of providing erroneous information. In addition, because applications typically are reviewed by underwriters, the underwriting process can take several days, whereas users typically prefer quicker decisions, preferably virtually instant decisions.

### BRIEF SUMMARY OF THE INVENTION

A system for real-time health care insurance underwriting is provided in accordance with an embodiment. The system includes a quotation module, a verification module, and an underwriting module. The quotation module receives user input relating to a user's health status via an online user interface. The verification module verifies the user input with information stored in a database and presents any inconsistencies to the user for validation. The underwriting module creates a debit score based on the user input and validated information, generates an underwriting decision, and presents one or more offers to sell insurance to the user.

A method for real-time health care insurance underwriting is provided in accordance with an embodiment. The method comprises, receiving user input relating to a user's health status, creating a list of inconsistencies by comparing the user input with information stored in a database, presenting the list of inconsistencies to the user, and receiving corrections to the user input. The method additionally comprises automatically creating a debit score based on the input and corrected input, automatically generating an underwriting decision whether to offer insurance to the user, presenting a set of quotations to the user, and receiving a decision from the user whether to accept one of the quotations.

A computer readable medium having stored thereon computer executable instructions for a method of real-time health care insurance underwriting is provided. The method comprises, receiving user input relating to a user's health status, creating a list of inconsistencies by comparing the user input with information stored in a database, and presenting the list of inconsistencies to the user and receiving corrections to the user input. The method additionally comprises automatically creating a debit score based on the input and corrected input, automatically generating an underwriting decision whether to offer insurance to the user, presenting a set of quotations to the user, and receiving a decision from the user whether to accept one of the quotations.

### BRIEF DESCRIPTION OF THE SEVERAL VIEWS OF THE DRAWING(S)

FIG. 1 is a schematic diagram of a system for real time insurance underwriting in accordance with an embodiment;

FIG. 2 shows a schematic diagram of the insurance underwriting system of FIG. 1 with a quotation system and user interface shown in greater detail.

FIG. 3 is procedural flow chart for the insurance underwriting system of FIG. 1 in accordance with an embodiment;

FIG. 3A is a screenshot of a portion of a health insurance application, in accordance with an embodiment;

FIG. 3B is a screenshot of another portion of the health insurance application of FIG. 3A.

FIG. 4 is a procedural flow chart for verifying the information of a health insurance application according to the insurance underwriting system of FIG. 1 in accordance with an embodiment;

FIG. 5 shows a procedural flow chart for providing a quick quotation according to the insurance underwriting system of FIG. 1 in accordance with an embodiment;

FIG. 6 is a screenshot from a system employing a quick quotation module, in accordance with an embodiment;

FIG. 7 is a screenshot from the system of FIG. 6; and

FIG. 8 is a screenshot from the system of FIG. 6.

### DETAILED DESCRIPTION OF THE INVENTION

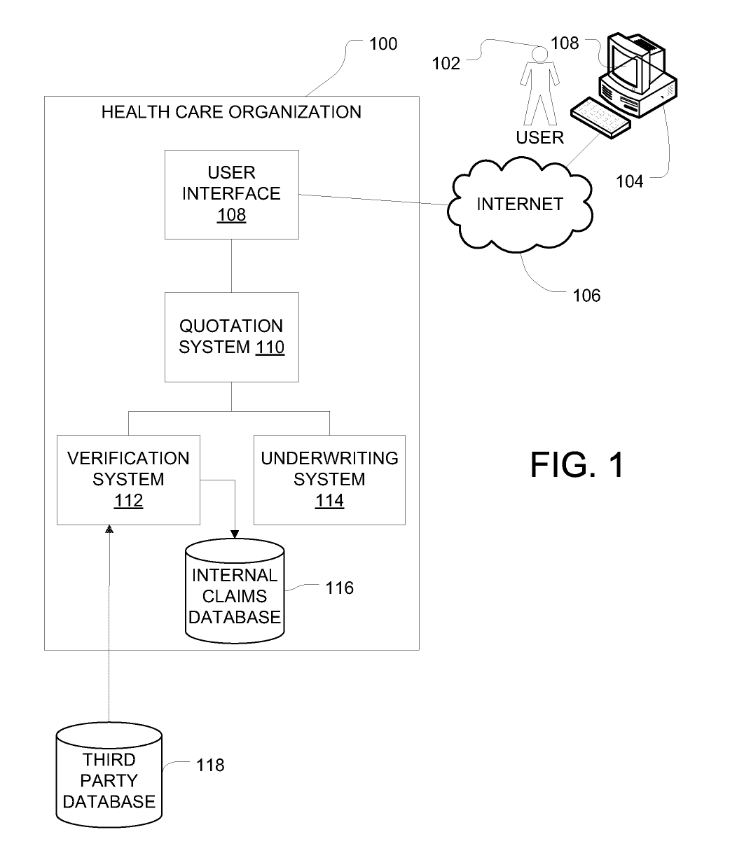

FIG. 1 shows a system for real-time health care insurance underwriting (hereinafter “insurance system”) in accordance with an embodiment. The insurance system includes a health care organization 100 to which a user 102 using a personal computer 104 is connected via a communications network 106 such as the Internet. The user 102 may be an individual, or a group of individuals, such as a family or a set of employees from a company. While the drawings show the user 102 using a personal computer 104, other devices such as cellular telephones or devices able to connect to other devices via a network may be used.

In accordance with an embodiment, the health care organization 100 provides a user interface 108 to the user 102 via the Internet 106. The user interface 108 may be visible to the user 102 by using a web browser or other computer program facilitating display of information provided by the health care organization 100. The user interface 108 communicates with a quotation system 110 which includes one or more computers or servers having a quotation module, which may be a computer readable medium storing executable instructions for providing insurance quotations to the user 102 via the user interface 108. The quotation system 110 interacts with a verification system 112 and an underwriting system 114. The verification system 112 includes a verification module, which is a computer readable medium storing computer executable instructions for verifying information provided by the user 102. The underwriting system 114 includes an underwriting module which is a computer readable medium having instructions for automated underwriting of health insurance according to information provided by the user 102. The quotation module, verification module, and underwriting module may be implemented on one or more servers or other computers and may include one or more data stores. While the drawings show the verification system 112 and underwriting system 114 communicating with the user interface 108 via the quotation system 110, the verification system 112 or underwriting system 114 may communicate with the user interface directly or through other systems.

The verification system 112 may interact with an internal claims database 116 and a third party database 118. The internal claims database 116 may include information about health insurance claims made by the user 102 in the past. For example, if the user 102 was previously insured by the health care organization 100, the internal claims database may include records containing information pertaining to claims for medical services or pharmaceutical products made by the user 102 when he or she was insured by the health care organization 100. The third party database 118 may include information similar to the information stored in the internal database 116. However, the third party database 118 may also include information provided by other entities. The third party database 118 may comprise additional databases such as a central database of health insurance claim information provided by health care organizations, including the health care organization 100 and third-party health care organizations. In an embodiment, the third party database 118 includes medical information provided by health care providers (e.g., claims data), as well as medical information provided by the user 102 during a patient-doctor interaction or otherwise. Suitable examples of a third party central database 118 include RSA Medical and Intelihealth® medical records databases.

In one embodiment, internal database 116 may include records submitted by the user 102 using a system for maintaining personal health records (PHR), which may include summaries of the user's health and medical history and which may be accessible online by the user 102, his or her physician, and/or health care organization, upon authenticating via proper credentials. As another example, the internal database 116 may include records from an integrated voice response system, which is an automated system for accepting telephone-originated user requests for claim status, account administration, and the like. The internal database 116 may include records relating to disease management call input, which is a health care organization application where a clinician or nurse interacts with a patient to manage a chronic disease, discuss treatment progress, and manage medications taken in connection with the disease. The internal database 116 may also include electronic medical record information, where an electronic medical record (EMR) application is used by doctors or other health care professionals at their place of business, such as a clinic, to enter patient data related to the patient's treatment and diagnosis, such as information relating to performed medical procedures, issued prescriptions, and the like.

The insurance system may also be configured to process batches of insurance applications. For instance, the quotation system 110 may include a server accessible by insurance agents via different protocols such as HTTP, FTP, etc.. An insurance agent may obtain application data from one or more consumers in order to form a batch of one or more insurance applications. The agent may obtain information manually, through its own user interface, or a user interface provided by the health care organization 100. The batch of applications may be uploaded to the FTP server for processing by the underwriting system 114. Any inconsistencies in any of the applications from the batch may be verified by the agent, who may contact appropriate consumers for more information. Any underwriting decisions and insurance offers may be communicated to the agent for acceptance by a consumer.

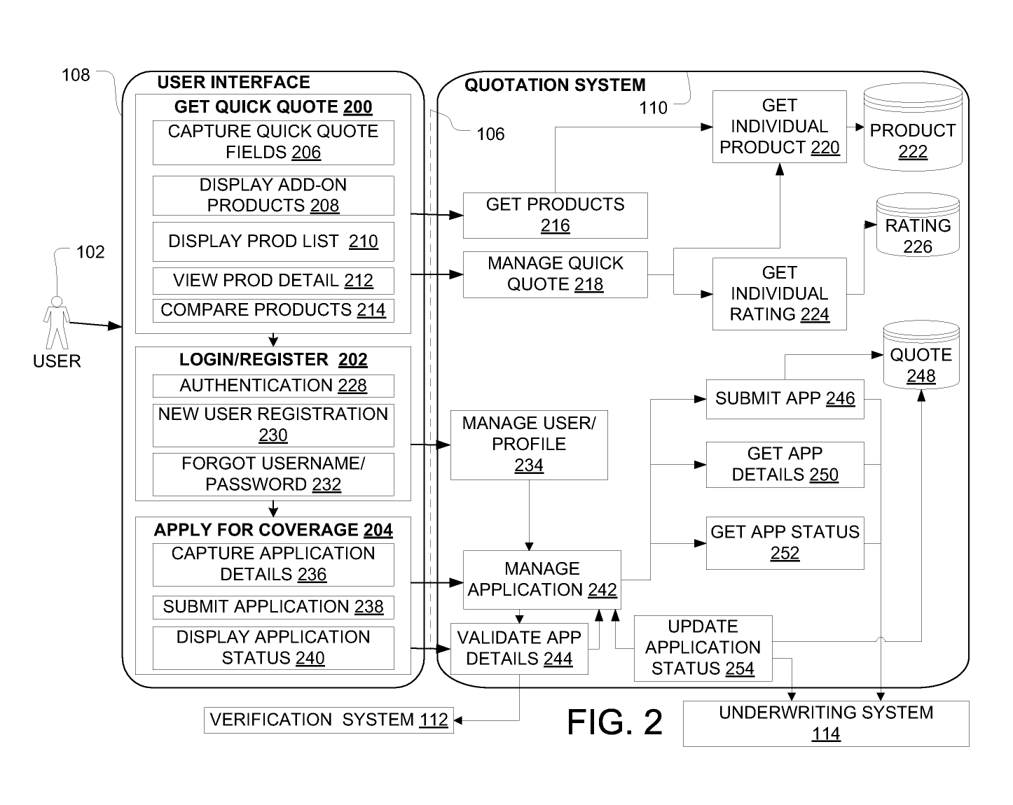

FIG. 2 shows features of the user interface 108 and the quotation system 110 in more detail. The features shown in FIG. 2 may be implemented in the quotation module of the quotation system 110. In an embodiment, the user interface 108 includes a quick quote sub-interface 200, where a quick quote is a base rate for an insurance plan corresponding to the lowest price of insurance available to a user. The user interface 108 further comprises a login/register sub-interface 202, and an application sub-interface 204.

As shown in FIG. 2, the quick quote sub-interface 200 includes several functions for interacting with the user 102. For example, the quick quote sub-interface 200 may include a function 206 for capturing quick quote fields. The function 206 is a function for allowing the user 102 to input basic input via the Internet 106 or other network and submit it to the quotation system 110. Basic input is minimum information about an individual or a group of individuals, such as age and zip code of primary residence (also known as “census” information), that is sufficient to determine a lowest available, or “best case,” health care insurance premium among the premiums offered by the health care organization 100. The quick quote sub-interface 200 may also include a function 208 for displaying add-on products. An add-on product is typically insurance or other products or services purchasable in addition to a health care insurance plan. For example, the health care organization 100 may sell numerous insurance plans which do not include coverage for optometry-related products and services such as eye examinations, prescription eye glasses, and contact lenses. For certain plans, the health care organization may offer users to purchase additional coverage for eye examinations, prescription eye glasses, and contact lenses. Other examples of add-on products include dental insurance and programs for discounts on medication or other products.

The quick quote sub-interface 200 may also include a function 210 for displaying a list of quick quotes and corresponding insurance plans. The list of quick quotes and corresponding insurance plans may include all the products available to a user having information corresponding to the information input into the function 206 captured in the quick quote fields. In addition, the quick quote sub-interface 200 may include a function 212 for viewing product details which, for each product displayed after employing the function 210, is an input selectable by the user 102 which, after selection, shows the selected product in more detail. For instance, if a user receives a quick quote for a specific insurance plan, the user may then select a “Details” button in order to see more specific details of the specific insurance plan such as policy limits, deductibles, and maximum out-of-pocket expenses. The quick quote sub-interface may also include a function 214 for comparing products which may allow the user 102 to select various products displayed after employing the function 210 and comparing one or more features of those products in a logical manner.

In an embodiment, the quotation system 110 includes functions for interacting with the quick quote sub-interface 200. For example, the quotation system 110 includes a function 216 for getting products and function 218 for managing quick quotes. The get products function 216 interacts with a function 220 for retrieving individual product information from an individual product database 222. Thus, if the user 102 receives a quick quote and wishes to see more details about the corresponding product, the user interacts with the function 212, which calls the function 220 in order to access details about the corresponding product from the individual product database 222.

The function 218 for managing quick quotes interacts with the function 220 for getting individual products and a function 224 for getting an individual rating. The get individual rating function 224 retrieves individual rating information which is based on the information provided by the user 102 via the function 206. A rating is a piece of information, such as a numerical score, which corresponds to the information provided by the user 102 using the capture quick quote fields function 206. The manage quick quote function 218 also uses the individual rating function 220 for retrieving products available to a user having the individual rating. Thus, in an embodiment, if the user 102 inputs an age of 45 years and a zip code of 98199, the function 218 calls the function 224 in order to retrieve an individual rating corresponding to a 45-year-old person living in zip code 98199. The individual rating is passed by the function 216 to the function 220 for retrieving all products available to a 45-year-old person living in zip code 98199.

The quick quote sub-interface 200 may also include additional functions. For instance, a function may be included that allows the user 102 to compare products of the health care organization 100 with similar competitor products. For instance, a user 102 may access the user interface 108 in order to compare products of the health care organization 100 and competitors of the health care organization 100. If the health care organization 100 has information relating to details and prices of any competitor's products, the user interface 100 would then compare the competitor products with products of the health care organization 100, perhaps by displaying basic details of both side-by-side. The user interface 108 may display check boxes to allow the user 102 to select which products he or she wishes to compare with products of competitors of the health care organization 100.

The log-in/register sub-interface 202 includes functions common to log-in/register sub-interfaces found in other Internet applications. For instance, the log-in/register sub-interface 202 may include an authentication function 228, a new user registration function 230, and a forgot user name/password function 232. The authentication function 228 may allow the user 102 to input information unique to the user 102 for access and management of data, products and other services unique to the user 102. Typically, the authentication function 228 includes the input of a user name unique to the user 102 and a password chosen by the user 102. The new user registration function 230 allows a user 102 who has never used online services of the health care organization 100 to input basic demographic data such as name, address, social security number, telephone number, and other information for creation of a new account with the health care organization 100.

A forgot user name/password function 232 may be used by user 102 who may have forgotten his or her user name or password. Typically, the forgotten user name password function 232 allows the user 102 to input information that typically only the user 102 would know, and in return provides the user 102 with the requested forgotten user name or password. Upon using the forgotten user name password function 232, user 102 may be required to select a new password for security purposes. The log-in/register sub-interface 202 interacts with a function 234 of the quotation system 110 for managing user profiles. The function 234 maintains accounts of users. For example, it may interact with a database for storing account information of users.

The application sub-interface 204 includes functions relating to completing health insurance applications. As an example, the application sub-interface 204 may include a function 236 for capturing application details which requests and receives information from the user 102, the information being applicable to an application for health insurance. For example, the function 236 may request demographic information from the user 102 and information about the user's health status, which includes detailed information about the user's health history, health conditions, and habits. The capture application details function 236 may ask the user 102 whether he or she has been diagnosed with certain medical conditions such as high blood pressure, heart disease, or diabetes, and may ask the user 102 if he or she smokes, drinks or engages in other activities which may affect his or her health. The capture application details function 236 may dynamically generate questions by basing one or more questions on prior answers received from the user 102. For example, if the user 102 indicates that he or she drinks alcohol, a later question may ask how many alcoholic drinks the user 102 drinks per day, whereas if the user 102 had indicated that he or she does not drink alcohol, then the capture application details function 236 would not ask how many alcoholic drinks the user 102 drinks per day. Similarly, if the user 102 had indicated that he or she has been diagnosed with diabetes, a subsequent question may ask specifically what type of diabetes was determined by the diagnosis, whereas a question about a specific form of diabetes would not appear in a subsequent question had the user not indicated a diagnosis of diabetes.

The application sub-interface 204 may also include a function 238 for submitting applications which allows the user 102 to pass the application formed by answering questions to the quotation system 110 to receive an underwriting decision. The application sub-interface 204 may also include a display application status function 240 which allows the user 102 to observe the real-time status of a submitted application.

The function 242 for managing applications interacts with a function 246 for submitting applications, which in turn interacts with an individual quote database 248 and the underwriting system 114. The function 242 also interacts with a function 250 for retrieving details about an application stored in a data store in the underwriting system 114 and a function 250 for retrieving an application's status, also stored in a data store in the underwriting system 114. In an embodiment, the user 102 may use the application sub-interface 204 to begin an application for health insurance. During the process in which the function 236 captures details about the application, the function 242 may call the function 246 to save the user's input in a data store for retrieval at a later time should the user 102 not complete the application in one sitting. When the user 102 completes the application and chooses to submit the application for underwriting using function 238, the function 244 submits information from the application to the verification system 112. If the verification system 112 finds inconsistencies in the application, the application sub-interface requests the user 102 to validate and/or provide more information. When the application is in a condition that an underwriting decision may be made, the function 242 calls the function 246 in order to submit the application to the underwriting system 114 to pass the application to the underwriting system 114 for making an underwriting decision. The underwriting system 114 may return real-time status indicating that an underwriting decision has been made, or that an underwriting decision is being delayed.

Once the application has been submitted to the underwriting system 114, the insurance system makes the application's status available to the user 102 via a function 254 which passes the application's status to the function 242, which makes the application's status available to the application sub-interface 204 via the function 240. For instance, when the user 102 submits the application to the underwriting system 114, the underwriting system 114 may make a real-time underwriting decision or may pass the application to an underwriter for review. If an underwriting decision has been made, the underwriting system 114 informs the user 102 in real-time, via the functions 254, 242, that his or her application has been approved or denied. If the underwriting system 114 passes the application to an underwriter for further review, the insurance system, via the functions 254, 242, informs the user 102 that his or her application is being reviewed.

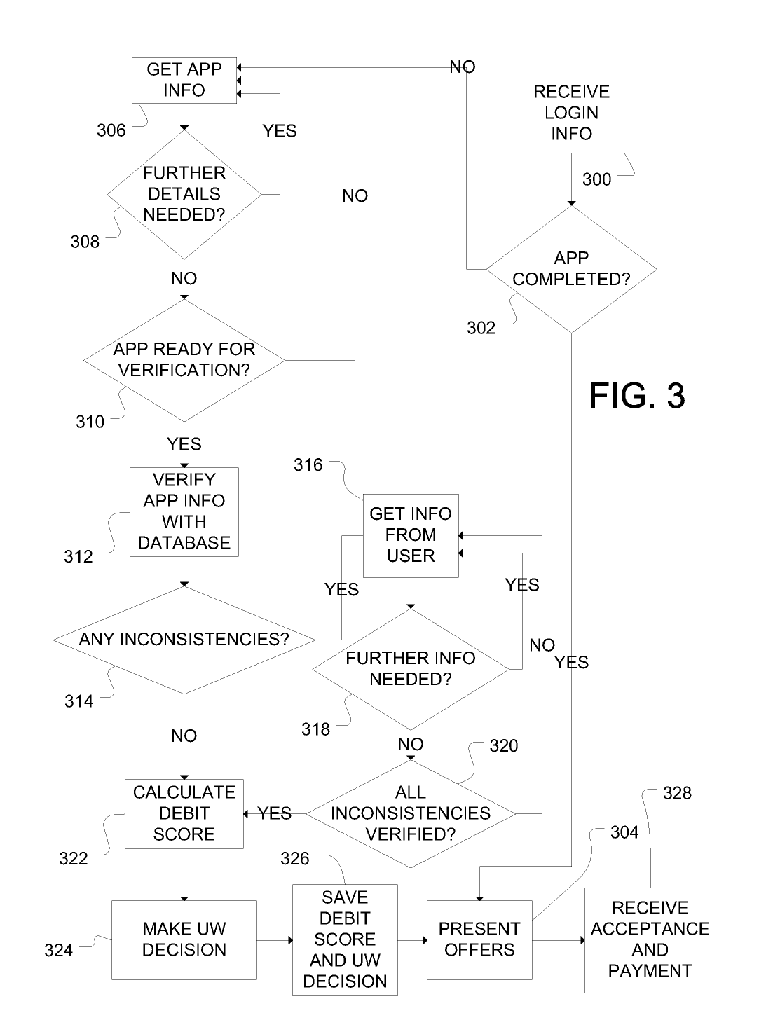

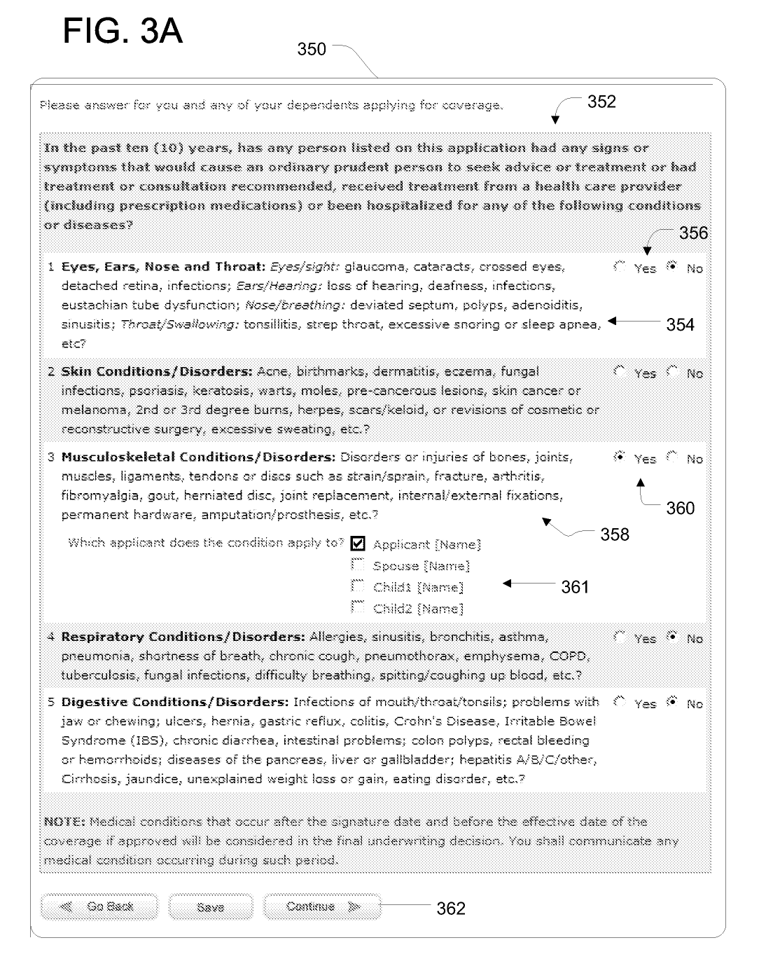

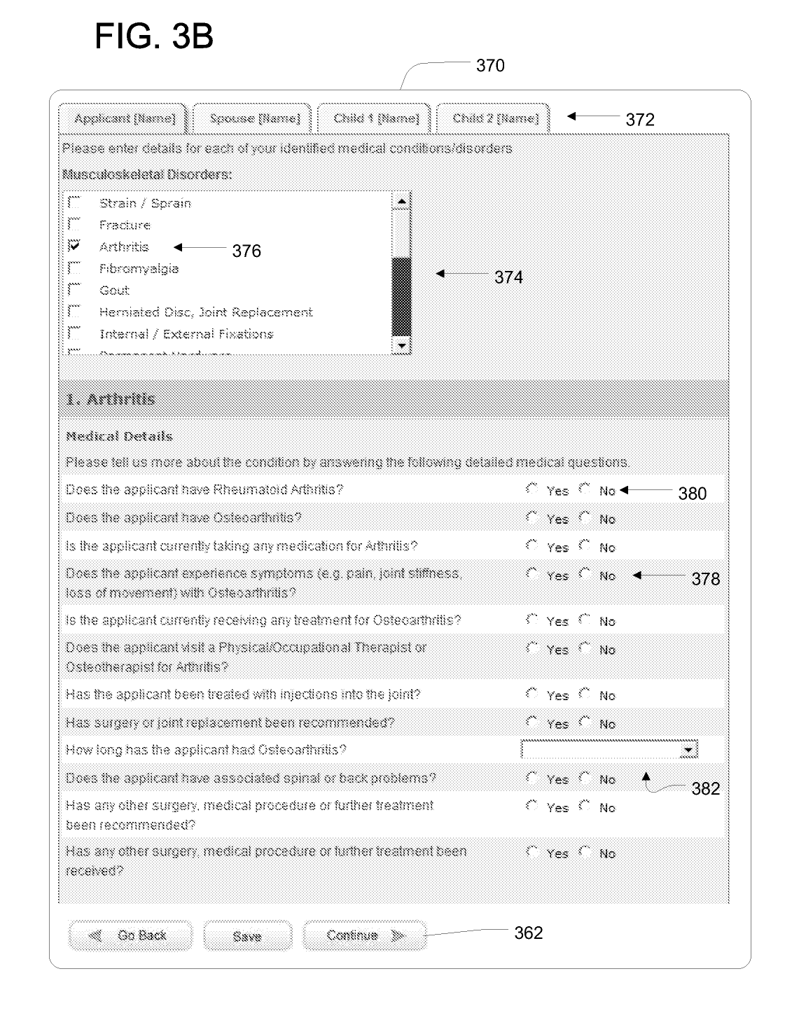

FIG. 3 shows a procedural flow chart for the insurance system in accordance with an embodiment. The steps shown in FIG. 3 may be implemented in the quotation module of the quotation system 110 by appropriately interacting with the verification module of the verification system 112 and underwriting module of the underwriting system 114, as described more fully below.

Beginning at step 300, the quotation system 110 receives log-in information from the user 102. If the log-in information from the user 102 is properly authenticated, the insurance system determines whether the user 102 has already completed an application for health insurance. If affirmative, the insurance system presents insurance offers, which may be stored in a data store and retrieved by the quotation system 110, to the user at step 304. Presenting insurance offers to user 102 at step 304 includes displaying one or more health insurance plans to the user 102 and gives prices for those plans presented to the user 102.

If step 302 determines that the user 102 has not already completed an application, he or she begins the application process at step 306 at which the insurance system requests and receives application information from the user 102. In an embodiment, step 306 comprises asking a subset of questions required for every insurance application. For instance, step 306 may comprise asking and receiving demographic information such as name, address, birthday, telephone number, and the like. Step 306 may also comprise asking and receiving a set of questions related to a general health topic, such as cardiovascular health. For instance, step 306 may include asking whether the user 102 has had a heart attack, has been diagnosed with high blood pressure, whether the user 102 has had heart or vascular surgery, or whether the user 102 has been diagnosed with high cholesterol.

At step 308, the insurance system determines whether further details are needed to the answers received, and if so, returns to step 306 for requesting more application information from the user 102. This process of requesting information and asking for more information if necessary is often referred to as asking drill-down questions, where a drill-down question is a question generated based on a previous answer, such as a more specific question asked after receiving a response to a general question. As an example, if the user 102 has indicated that he or she has had a heart attack, the insurance system step 308 would determine that more information is needed and return to step 306 to ask details related to the heart attack, such as when it occurred. After receiving details related to the heart attack, the insurance system at step 308 would determine whether yet even more information was needed. For instance, if the heart attack was recent, the insurance system at step 308 may return to step 306 to request information about any health care provided to the user 102 in connection with the heart attack, such as contact information for the cardiologist in charge of the user's care.

If the insurance system at step 308 determines that no further details are needed, at step 310 the insurance system determines whether the application is ready for verification. In an embodiment, step 310 determines whether answers to all questions required of the application have been asked. For instance, during the application process, the insurance system at step 310 may determine that it has not asked and received answers to questions concerning cardiovascular health and return to step 306 to ask cardiovascular-related questions, as described above. After receiving answers to the cardiovascular questions and corresponding drill-down questions, the insurance system may return to step 310 and determine that it has not asked and received answers to questions relating to urological health and, therefore, return to step 306 to ask urology-related questions and drill down questions deemed necessary by step 308. When answers to all related questions have been received, the insurance system proceeds to step 312 where it verifies the answers provided by the user 102. At any time during the application process, the user interface 108 can include a tracker (not shown) that indicates to the user 102 how much of an application remains. For instance, the user interface 108 can include a series of boxes, each box corresponding to a step in the application process. At any particular step in the application process, the user interface 108, in an embodiment, illuminates the box corresponding to that step. For example, if the fifth out of ten boxes was illuminated, the user 102 would know that he or she was approximately half way through the application process.

At step 312, the insurance system verifies the application information with a database such as the internal claims database 116 or the third party database 118. Verification of the application, specifically steps 314 through 320 shown in FIG. 3, may involve passing application data from the quotation system 110 to the verification system 112, shown in FIG. 1. When verifying the information with a database at step 314, the insurance system determines whether there are any inconsistencies between the application information provided by the user 102 and the database at step 314 and creates a list of inconsistencies to verify with the user 102. If there are inconsistencies at step 314, the insurance system proceeds to step 316 where it requests and receives information about inconsistency from the user 102. For example, if the application information indicates that the user 102 has stated that he or she has not been diagnosed with a heart condition, but the claims database 116 and/or third party database 118 shows that the user 102 has previously made a claim for blood pressure medication, which may be associated with a potential heart condition, the insurance system at step 316 will inform the user 102 that he or she has made a claim for blood pressure medication on a given date and allow the user 102 to update the application information accordingly. Preferably, the system will present the user 102 with additional dynamically generated questions in order to drill down on additional detail associated with the discrepancy. Another example would be, if the user 102 has stated that he or she has not been diagnosed with diabetes, but the claims database 116 and/or third party database 118 shows that the user 102 has previously made a claim for insulin medication, which may be associated with a potential diabetes condition, the insurance system at step 316 will inform the user 102 that he or she has made a claim for insulin medication on a given date and allow the user 102 to update the application information accordingly. Preferably, the system will present the user 102 with additional dynamically generated questions in order to drill down for additional details and, alternatively, the user 102 can provide instructions for that the information presented is not accurate and continue the process of application. In appropriate circumstances, such as when one or more inconsistencies potentially affect an ultimate underwriting decision and/or price for insurance, the user 102 can be provided the opportunity to talk to an underwriter to discuss any inconsistencies.

At step 318, the insurance system determines whether further information is needed after receiving information about the inconsistency from the user 102 at step 316. In the previous example, for instance, the insurance system may return to step 316 in order to request the user 102 to provide information about whether the blood pressure medication was for a diagnosed chronic condition or for a temporary condition and, after receiving an answer, return to step 318 to determine whether further information is needed.

If no further information is needed about the particular inconsistency, the insurance system in step 320 determines whether all the inconsistencies have been verified. If all the inconsistencies have not been verified, the insurance system returns to step 316 and requests and receives information from the user 102 about the next inconsistency in the list of inconsistencies. The insurance system may also direct the user 102 to contact the health care organization 100 to speak to a representative of the health care organization 100 in order to verify one or more inconsistencies. If all the inconsistencies have been verified, the insurance system proceeds to make an underwriting decision by calculating a debit score for the user 102 and determining premiums for any applicable insurance plans. Generally, this process involves analyzing the application data through a rules engine application having stored therein processes and criteria for making underwriting decisions. A suitable example of a rules engine application includes a Blaze Advisor™ application available from Fair Isaac Corporation of 901 Marquette Avenue, Suite 3200, Minneapolis, Minn. 55402. Other suitable examples include rules engines known under the names of Selectica®, available from Selectica, Inc., located at 1740 Technology Drive, Suite 450, San Jose, Calif. 95110, and Fiserv®, available from Fiserv, Inc., located at 255 Fiserv Drive, Brookfield, Wis. 53045. A rules engine can also be made by the health care organization 100 itself.

In an embodiment, the insurance system proceeds to step 322 where it calculates a debit score, which may comprise sending information provided by the user 102 to the underwriting system 114. In general, calculating a debit score 322 includes taking application data provided by the user 102 or gathered from other sources and calculating a numerical score. For example, calculation of a debit score may begin by assuming the user 102 a score of zero and increasing the score based on information provided by the user 102 which may adversely affect his or her health. Thus, if a user 102 has been previously diagnosed with diabetes, a set value may be added to his or her score. Likewise, if a user 102 smokes, another set value may be added to his or her score. In this manner, a lower debit score corresponds to lower insurance rates because users with lower scores are less likely to require medical services to be paid for at least partially by the health care organization 100. Other methods for calculating a debit score may also be used. For example, the user 102 may start with a set value from which factors adversely affecting his or her health may cause deductions from the user's score so that higher scores correspond to less risk to the health care organization 100 and, as a result, lower premiums.

Once the debit score had been calculated at step 322, the insurance system makes an underwriting decision at step 324 based at least in part on the debit score of the user 102. Making an underwriting decision may also be completed by the underwriting module of the underwriting system 112 and includes making a decision whether or not to offer any health insurance plans to the user 102 and determining premiums for the plans. For instance, if the user 102 has a particularly high debit score, the health care organization 100 may decide to only offer insurance to the user 102 under several plans designed for people having high debit scores. In general, the insurance system may make a decision to offer any number of plans to the user 102 or no plans at all.

When the underwriting decision is made, the insurance system saves the debit score and underwriting decision at step 326. Step 326 may involve storing the underwriting decision in a data store, such as the individual quote database 248, shown in FIG. 2. The debit score and underwriting decision are saved so that the user 102 may log into the quotation system 110 and purchase health insurance from the health insurance organization 100 at a later time without having to go through the process of submitting an application.

Once the debit score and underwriting decision are saved, the insurance system proceeds to step 304, which as described earlier, offers to insure the user 102 are presented to the user 102. Step 304 may also comprise displaying any add-on products available to the insurance plans offered. At step 328, the insurance system may receive acceptance of an offer and payment from the user 102 for insurance at step 328 should the user 102 decide that he or she wishes to purchase any of the plans offered to him or her.

If the user 102 indicates that he or she would like to purchase a particular insurance plan, the user interface 108 may also recommend other plans before the user 102 makes a final decision. For example, in an embodiment, if the user 102 indicates that he or she would like to purchase a specific plan at step 328, the user interface 108 may present one or more alternate plans before receiving payment from the user 102. For instance, if another plan has similar features to the plan chosen by the user but costs less, the user interface may present an offer for the other plan to the user and may emphasize the lower cost.

If the user 102 is a group of individuals, such as a family, the insurance system 110 may determine the cost to insure the whole group, compare the cost to insure the group by insuring partitions of the group separately and summing the costs, and present the user 102 with the lowest cost to insure the group. For example, if the user 102 is a family consisting of a mother, a father, and a child, the insurance system may calculate a debit score and generate an underwriting decision for the whole family. The insurance system may also calculate a debit score and generate an underwriting decision for each member of the family separately, and add the individual costs to arrive at another price for insuring the family. The insurance system may also calculate a debit score and generate an underwriting decision for the mother and father as a group and the child individually, and add the costs to arrive at a third price for insuring the family. In general, the insurance system may partition the family into any possible combination of subsets and calculate a debit score and underwriting decision for each subset, and then determine the cost to insure the family by adding up the costs to insure each subset. The insurance system can inform the family of the least expensive way of insuring the family and offer that way to the family via the user interface 108. In addition, the insurance system can limit the number of applicants applying together in its calculations. For example, if a family with two parents and four children applies for insurance, the insurance system can create a price to provide insurance to the family based on having a maximum of two children. In this manner, a family of six could purchase health insurance as if for a family of four. When the number in a group applying together for health insurance exceeds the maximum, the insurance system can use debit scores from a subset of the group, such as the four highest individual debit scores.

FIG. 3A shows an example of a portion of a health insurance application provided via an online user interface in accordance with an embodiment of a system for providing real-time insurance underwriting. The example shown in FIG. 3A includes a page 350 of an application having instructions 352 for answering a series of health-related questions. For instance a first question 354 asks whether any person listed on the application had any of several listed medical issues relating to the eyes, ears, nose, and throat in the last ten years. A pair of radio buttons 356 allow the user 102 to choose “yes” or “no” to indicate that someone listed in the application has had at least one issue relating to one of the listed conditions. In the example shown, the “no” button of the radio buttons 356 is selected.

A similar question 358 appears as the third question on the page 350, the question 358 relating to musculoskeletal conditions or disorders. As with the eyes/ears/nose/throat question 354, the musculoskeletal-related question 358 includes a pair of radio buttons 360. As shown in the example, the “yes” radio button of the radio buttons 360 is selected. As the “yes” radio button has been selected, an additional drill-down question 361 has appeared below the question 358. In an embodiment, the drill-down question 361 can appear as soon as the user 102 selects the “yes” radio button, although it can appear at other times, such as later in the application process on another page. In this instance, the drill-down question 361 asks which of the people listed in the application have had an issue with one of the conditions listed in the question 358, the choices in this example being “Applicant”, “Spouse”, “Child1”, and “Child2”. In the example shown, only the “Applicant” checkbox is checked. A series of checkboxes allows the user 102 (Applicant) to choose one or more of the people listed. In this manner, the drill-down question only appears when there is a need for more information from the user 102. Presenting the application in this manner simplifies the process of applying for insurance by requiring in-depth answers to questions only when necessary, thereby reducing the application process and making it more likely that a consumer will finish the application and reducing the chance for errors. When all of the questions have been answered, the user 102 can select a “Continue” button 362 in order to proceed with the application.

FIG. 3B shows another page 370 of the application shown in FIG. 3A. A series of tabs 372 lines the top of the page 370, each tab corresponding to a person listed in the application and allowing the user 102 to select a tab in order to enter specific information about each person listed. In the example shown, the tab corresponding to the Applicant is selected. Because the user 102 indicated that he or she had a musculoskeletal condition, as described above, a question 374 asks the user 102 to enter details about any musculoskeletal conditions or disorders he or she has had. In an embodiment, the question 374 appears as a series of checkboxes, each for selecting a single musculoskeletal condition or disorder. In the example shown, the user 102 has selected an “Arthritis” checkbox 376 and, as a result, additional drill-down questions relating to arthritis have appeared under the question 374. In an embodiment, the additional drill-down questions appear dynamically as a corresponding checkbox is selected, although the additional drill-down questions can appear in other manners, such as later in the application process. In addition, selecting additional checkboxes results in additional drill-down questions corresponding to other conditions or disorders also appearing below the question 274.

As examples of drill-down questions applicable to Arthritis, the page 370 includes a question 380 asking whether the user has had rheumatoid arthritis, and a question 378 asking whether the applicant experiences symptoms with osteoarthritis. Both of the questions include radio buttons allowing the user 102 to answer “yes” or “no”. As another example, a question 382 asking how long the applicant has had osteoarthritis also appears on the page 370. In an embodiment, a drop down box allows the user 102 to choose from a list of possible time periods such as “less than one year”, “one to five years”, and “more than five years”. As with the page 350 in FIG. 3A, the page 370 in FIG. 3B includes a “Continue” button 362 allowing the user 102 to submit the information he or she has input and continue further in the application process.

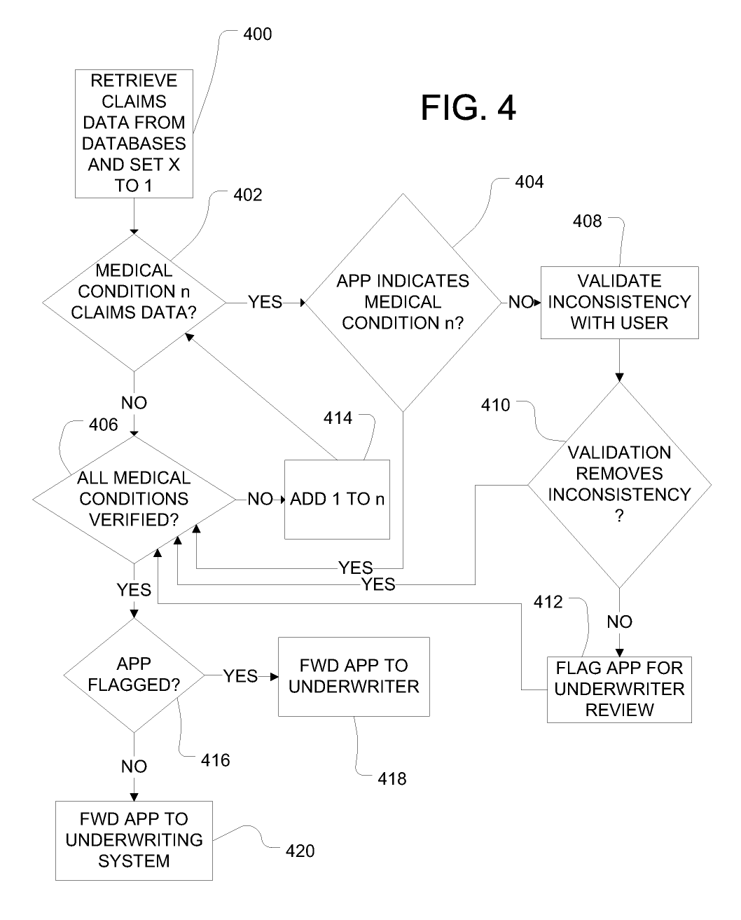

FIG. 4 shows a procedural flow chart for the process of verifying an application submitted by the user 102 in accordance with an embodiment. Beginning with the step 400, the insurance system retrieves claims data from internal and external databases and sets a variable n to the value of 1, where n is an integer. At step 402, the insurance system determines whether the claims data indicates the user 102 has indicated medical status n, where “medical condition n” refers to the nth status in a list of possible medical statuses to be verified by the verification system 112. For instance, in an embodiment, medical condition 1 is past or present tobacco use, medical condition 2 is heart disease, medical condition 3 is kidney disease, medical condition 4 is alcoholism, et cetera.

If the claim's data does indicate medical condition n, then the insurance system determines whether the application submitted by the user 102 indicates medical condition n at step 404. As an example, if the insurance system at step 402 determines that the claims data shows that the user 102 has previously submitted a claim for therapy to stop smoking three years ago, at step 404 the insurance system will determine whether the user 102 has indicated in his or her application that he or she has smoked cigarettes within the last five years.

If the results of step 402 and step 404 agree, the insurance system proceeds to step 406 to determine whether all medical conditions have been verified. If the results of steps 402 and 404 do not agree, the inconsistency is presented to the applicant and a request is made for additional information regarding the inconsistency 408. For instance, in the previous example the insurance system may ask the user 102 whether or not he or she would like to change his or her answer to the question of whether or not he or she has smoked in the past five years. At step 410, the insurance system determines whether the answer received by the user 102 removes the inconsistency. If so, the insurance system proceeds to step 406 to determine whether or not all medical conditions have been verified. If the additional information provided by the user 102 at step 408 does not remove the inconsistency, the insurance system proceeds to step 412, where the application is flagged for underwriter review. Continuing with the previous example, if, after being confronted with the inconsistency, the user indicated that he or she has never smoked cigarettes, the application is flagged for review for an underwriter who may review the claims data to determine whether or not an error has been made in the claims database or whether another reason adequately explains the inconsistency. In addition to or as an alternative to flagging an application for underwriter review, for every inconsistency found between the application and the claims data, the insurance system may assume results adverse to the user's health. In this manner, an automated underwriting decision may be made which does not under price any insurance plans.

At step 406, where the insurance system determines whether all medical conditions have been verified, if a medical condition has not been verified, the insurance system proceeds to step 414 where it adds 1 to n and returns to step 402 to verify the next medical condition. This process is repeated until the insurance system at step 406 determines that all medical conditions have been verified. Once all medical conditions have been verified, the insurance system at step 416 determines whether the application is flagged for underwriter review. If the application is flagged for underwriter review at step 418, the insurance system forwards the application to an underwriter for personal attention. If the application is not flagged for underwriter review, the insurance system proceeds to step 420 and forwards the application to the underwriting system 114 for making a real-time underwriting decision.

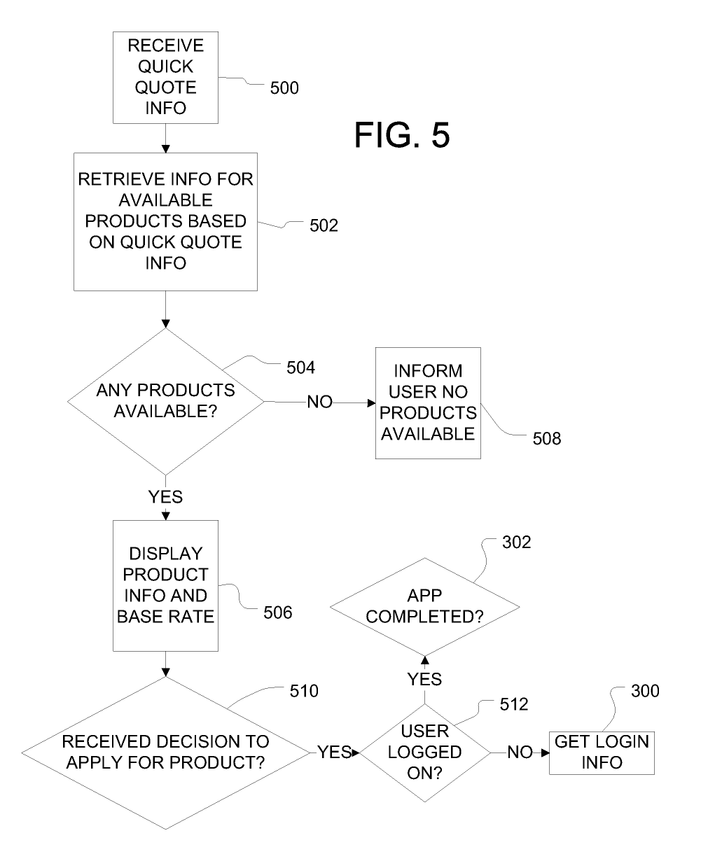

FIG. 5 shows a procedural flow chart for a quick quotation module, the quick quotation module for providing a quick quotation in accordance with an embodiment. In an embodiment, a quick quotation module is an online interface for providing streamlined insurance quotes by reducing the number of data input fields and collecting only basic input to provide the quotes. In an embodiment, the basis input is a minimum amount of information needed to determine a lowest, or ‘best case,’ premium, although it can be an amount of information needed to determine other premiums, such as an average or median premium corresponding to the basic input. Preferably, the quick quotation module presents requested health insurance quotes after collecting the basic input via two or less input screens. However, the quick quotation module can present requested health insurance quotes after collecting the basic information in other ways. For example, the basic input can be collected on one input screen using one, two, or more data input fields. An input screen can also automatically adapt after receiving a portion of the basic information so that the input screen is configured to receive a remainder of basic information, the remainder of basic information depending on the portion of basic information already entered.

At step 500, the insurance system receives quick quote information from the user 102, for example, via the user interface 108 shown in FIG. 2. At step 502, the insurance system receives product information for products available to the user 102 according to the quick quote information here she has provided. At step 514, the insurance system determines whether step 502 has returned any products available to the user 102. If no products are available to the user 102, the insurance system via the user interface 108 informs the user that no products are available. If products are available to the user 102, at step 506 the insurance system displays product information and the base rate available for the products available to the user 102.

At step 510, the insurance system determines whether it has received a decision from the user 102 to apply for one or more of the products shown in step 506. If the insurance system has received a decision to apply for one or more of the products, the insurance system proceeds to step 512 and determines whether or not the user 102 is logged on. If the user 102 is not logged on, the insurance system proceeds to step 300 shown in FIG. 3, and gets log in information from the user 102. If the user 102 is logged on, the insurance system proceeds to begin the application process. For example, by proceeding to step 306 in FIG. 3.

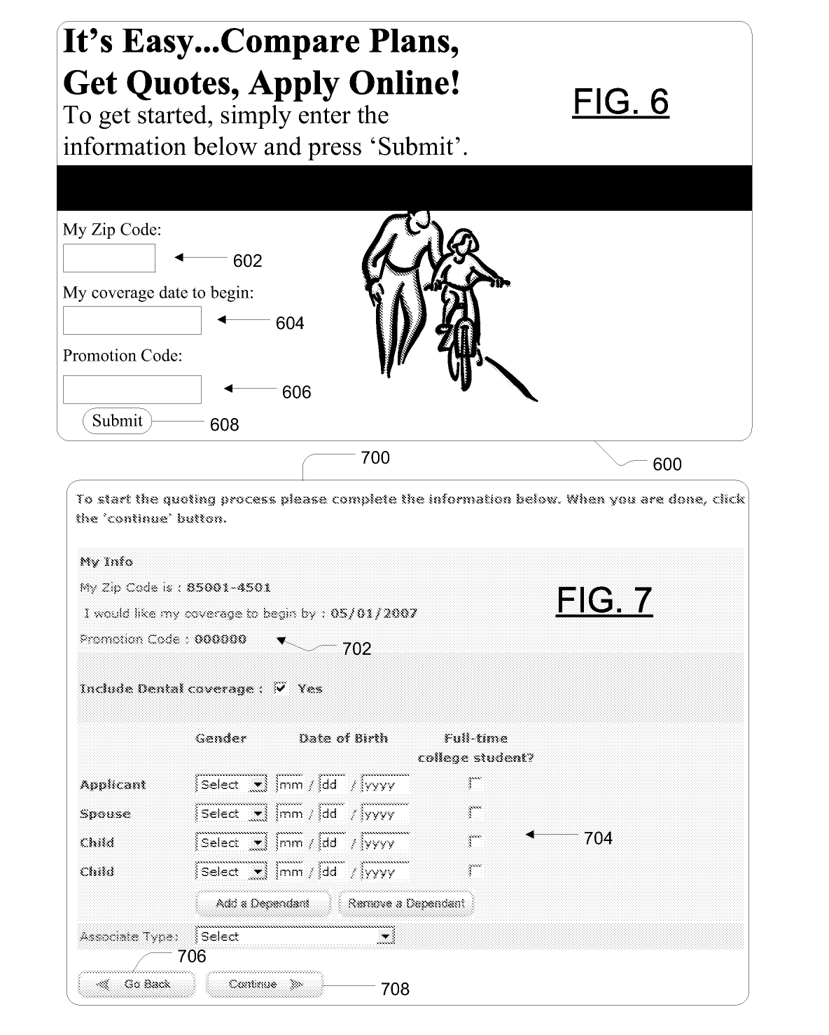

FIG. 6 shows an example of a page 600 presented to the user 102 over an online interface in order to provide the user 102 a quick quotation. In an embodiment, the page 600 includes several controls allowing the user 102 to enter basic information. For example, an input box 602 requests the zip code of the user 102. The user 102 enters his or her zip code by entering a numerical value into the box. An input box 604 requests a date from which the user 102 would like coverage to begin, such as a date when current insurance coverage of the user 102 expires. A promotion code box 606 allows the user 102 to input a code he or she has received, the code corresponding to a promotion of the health care organization 100 which, for example, offers a discount or other benefit to consumers with a valid code. A “start” button 608 allows the user 102 to submit any information input in the boxes 602, 604, 606 and proceed to a second page 700, shown in FIG. 7.

The second page 700 includes a summary 702 of the information submitted by the user 102 on the first page 600 shown in FIG. 6. A series of inputs 704 allow the user 102 to specify for whom he or she is seeking a quotation for health insurance. In an embodiment, the series of inputs correspond to persons for whom applications for health insurance are commonly made. For instance, as shown in the drawing, the series of inputs allows the user 102 to specify himself or herself, a spouse, and up to two children by inputting the gender and date of birth of each. A button 706 for adding a dependent to the list allows the user to specify more dependents than shown on the page 700. Other controls can also be included, such as a control specifying whether the user 102 would like to include dental insurance in a quotation. In addition, the input controls on the first page 600 shown in FIG. 6 can be combined with the input controls on the second page 700 shown in FIG. 7 so that the user 102 can provide all information necessary for a quick quotation on one page. In either case, a “continue” button 708 is provided for submitting the information provided by the user 102 in order to retrieve one or more quick quotations available according to the information provided.

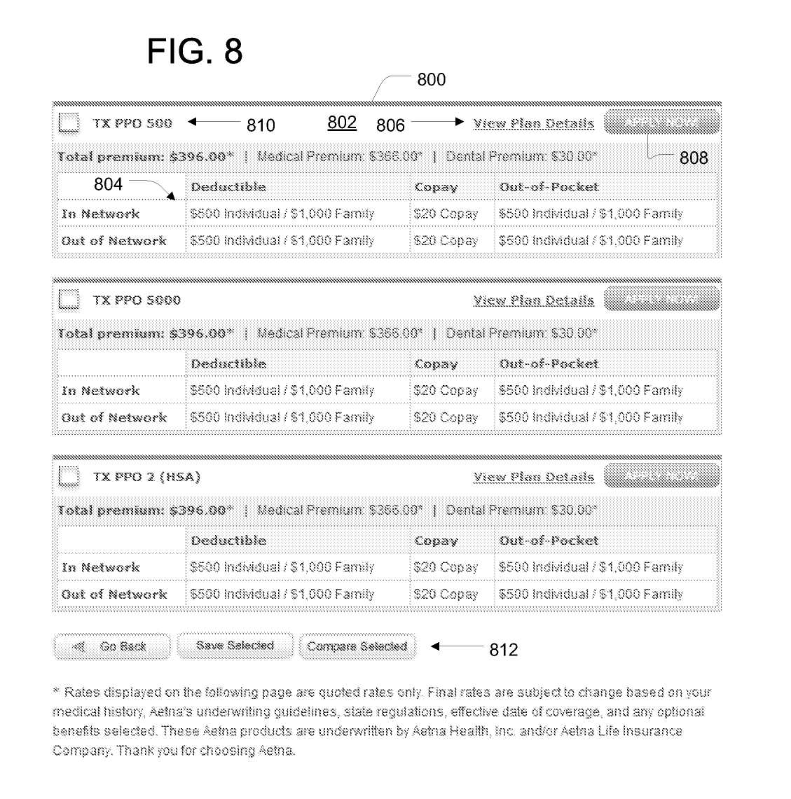

FIG. 8 shows a page 800 having examples of quick quotations corresponding to information provided by a consumer on the pages 600, 700 shown in FIGS. 6 and 7, respectively. For example, a first quick quotation 802 shows a quick-quotation for a plan titled “TX PPO 500”. The quick quotation 802 shows a total premium of $396.00, $366.00 of which is for medical insurance and $30.00 of which is for dental insurance. The quick quotation 802 includes a table 804 showing basic information about the quick quotation 802, such as applicable deductibles, copay amounts, and maximum out-of-pocket expenses corresponding to in-network care (from medical providers contracting with the health care organization 100) and out-of-network care (from medical providers not contracting with the health care organization 100). A link 806 is provided for viewing the details of the quick quotation 802 to allow the user 102 to view more specific information pertaining to the quick quotation 802. A button 808 is provided to allow the user 102 to apply for an insurance plan corresponding to the quick quotation 802. By selecting the button 808, the user 102 goes through the application process, as described above, in order to receive an underwriting decision and any offers to purchase insurance, which may have prices differing from that shown in the quick quotation 802.

Similar information and features are provided for other insurance plans available according to the information submitted by the user 102. In an embodiment, each quick quotation listed on the page 800 includes a checkbox, such as the checkbox 810 so that the user 102 can compare details of each quick quotation side-by-side or in another manner by selecting a button 812 provided for comparing the quick quotations having selected checkboxes.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for real-time health care insurance underwriting, comprising:
a quotation module for receiving user input relating to a user's health status via an online user interface;
a verification module for verifying the user input against information stored in a database to form a list of one or more inconsistencies, the verification module capable of presenting the user via the online user interface with a request to validate at least some information within the user input based on the list of one or more inconsistencies; and
an underwriting module for automatically creating a debit score based on one or more of at least a portion of the user input and the validated information, the underwriting module generating an underwriting decision based at least in part on the debit score, and communicating the underwriting decision to the quotation module for presenting one or more offers to sell health care insurance to the user via the online user interface, the one or more offers based on the underwriting decision.

2. The system of claim 1, wherein the quotation module receives the user input in response to a first series of questions, the first series of questions dynamically generated by presenting at least one question to the user, receiving an answer to the at least one question, and determining a subsequent question within the series based on the answer.

3. The system of claim 1, further comprising a quick quotation module for receiving basic input from the user via the online user interface, the basic input comprising minimum information for determining a best case health care insurance premium, and presenting one or more quick quotations comprising the best case health care insurance premium to the user.

4. The system of claim 3, wherein the quick quotation module presents one or more competitor quotations with the one or more quick quotations, the competitor quotation corresponding to an insurance premium published by a third party.

5. The system of claim 1, wherein the database comprises the user's health records including one or more of health care insurance claim information and user entered health information collected from at least one source, the at least one source selected from the group consisting of an online personal health record, an electronic medical record, a disease management call, and an integrated voice response system.

6. The system of claim 5 wherein the database comprises one or more of a health care insurance provider database and a central database for collecting the health records from a plurality of health care insurance providers.

7. The system of claim 1, wherein the quotation module presents a first series of questions to the user and receives a first series of answers to the first series of questions from the user via the online user interface.

8. The system of claim 1, wherein the system is operated by a health care organization and wherein the request to validate at least some information within the user input based on the list of one or more inconsistencies comprises a request to contact the health care organization to validate at least some information within the user input.

9. The system of claim 1, further comprising:
an underwriting storage database for storing underwriting decisions and debit scores for subsequent retrieval by the quotation module; and
a login module for requesting and receiving login information unique to the user and, upon receipt of the login information, retrieving one or more of the underwriting decision and the debit score corresponding to the user from the storage database.

10. The system of claim 1, further comprising at least one of an FTP server and HTTP Server for receiving a batch of insurance applications, the batch of insurance applications comprising a plurality of responses to a list of insurance application questions, the underwriting module further configured for automatically creating a batch of debit scores based on at least a portion of each insurance application within the batch of applications, generating a batch of underwriting decisions based at least in part on the batch of debit scores, and communicating the batch of underwriting decisions to the quotation module for communicating a batch of offers to sell insurance to a plurality of users, the batch of offers based at least in part on the batch of underwriting decisions.

11. A method for real-time online health care insurance underwriting, comprising:
receiving user input relating to a user's health status over a communications network;
creating a list of one or more inconsistencies by comparing at least a portion of the user input with information stored in a database;
presenting the list of one or more inconsistencies to the user and receiving over the communications network corrected input based on corrections to user input;
automatically creating a debit score based at least in part on user input and corrected input;
automatically generating an underwriting decision whether to offer insurance to the user, the underwriting decision based at least in part on the debit score;
presenting a set of quotations to the user over the communications network, each quotation comprising an offer to provide health care insurance to the user according to a specific insurance plan, each quotation based on the underwriting decision; and
receiving over the communications network a decision from the user whether to accept one of the quotations.

12. The method of claim 11, further comprising storing the debit score in a storage medium for a period of time and retrieving the debit score after the period of time.

13. The method of claim 11, further comprising:
receiving user basic input over the communications network; and
providing a set of quick quotations to the user over the communications network, each quick quotation comprising a selling price for insurance based at least in part on the basic input.

14. The method of claim 11, further comprising presenting at least one alternate quotation to the user over the communications network, the alternate quotation comprising an alternative quotation to the quotation corresponding to the decision of the user.

15. The method of claim 11, wherein the user input comprises responses to a set of questions dynamically generated by receiving answers to one or more of the set of questions and determining one or more subsequent questions based on the answers to the one or more of the set of questions.

16. The method of claim 11, further comprising:
receiving a batch of applications over the communications network from an agent, each application comprising health information of an applicant from a set of applicants;
automatically creating a batch of applicant debit scores, each applicant debit score corresponding to an applicant;
automatically creating a batch of underwriting decisions, each underwriting decision of the batch of underwriting decisions corresponding to a decision whether to offer insurance to an applicant; and
providing to the agent over the communications network a batch of quotations based on the batch of underwriting decisions and the batch of debit scores, each quotation comprising an offer to provide insurance to an applicant according to a specific insurance plan.

17. The method of claim 11, wherein the user is a set of individuals insurable under a common insurance plan and wherein the method further comprises:
partitioning the set of individuals into subsets of individuals; and
for each subset of individuals, automatically creating a subset debit score based at least in part on the user input and corrected input, generating a subset underwriting decision based at least in part on the subset debit score, and presenting a set of subset quotations, each subset quotation comprising an offer to provide insurance to the subset of individuals according to a specific insurance plan, each subset quotation based at least in part on the debit score and underwriting decision.

18. The method of claim 17, further comprising, for a specific insurance plan, presenting a first and second cost to provide insurance to the user, the first cost corresponding to a price of insurance for the complete set of individuals, the second cost corresponding to the sum of prices of insurance for each subset of individuals.

19. The method of claim 11, wherein creating a list of one or more inconsistencies comprises interfacing with a third-party application for accessing the database.

20. The method of claim 11, further comprising determining whether the user input and corrected input is adequate for automatically generating an underwriting decision.

21. A computer readable medium having stored thereon computer executable instructions for real-time online health care insurance underwriting, the instructions comprising:
receiving user input relating to a user's health status over a communications network;
creating a list of one or more inconsistencies by comparing at least a portion of the user input with information stored in a database;
presenting the list of one or more inconsistencies to the user and receiving over the communications network corrected input based on corrections to user input;
automatically creating a debit score based at least in part on the user input and the corrected input;
automatically generating an underwriting decision whether to offer insurance to the user, the underwriting decision based at least in part on the debit score;
presenting a set of quotations to the user over the communications network, each quotation comprising an offer to provide health care insurance to the user according to a specific insurance plan, each quotation based on the underwriting decision; and
receiving over the communications network a decision from the user whether to accept one of the quotations.

22. The computer readable medium of claim 21 wherein the instructions further comprise receiving the user input in response to a first series of questions, the first series of questions dynamically generated by presenting at least one question to the user, receiving an answer to the at least one question, and determining a subsequent question within the series based on the answer.
